(19) United States
(12) Patent Application Publication
(10) Pub. No.: US 2026/0040041 A1
(43) Pub. Date: Feb. 5, 2026

(54) OBJECT SENSING METHOD USING MOBILE COMMUNICATION AND COMMUNICATION SYSTEM PROVIDING THE SAME

(71) Applicant: Electronics and Telecommunications Research Institute, Daejeon (KR)

(72) Inventor: Soohwan LEE, Daejeon (KR)

(73) Assignee: Electronics and Telecommunications Research Institute, Daejeon (KR)

(21) Appl. No.: 19/286,340

(22) Filed: Jul. 31, 2025

(30) Foreign Application Priority Data
Jul. 31, 2024 (KR) 10-2024-0101843
Jul. 30, 2025 (KR) 10-2025-0104336

(51) Int. Cl. H04W 4/38; H04W 8/22; H04W 60/04

(52) U.S. Cl. CPC H04W 4/38; H04W 8/22; H04W 60/04

(57) ABSTRACT

A method of object sensing, performed by a core network according to an exemplary embodiment of the present disclosure, may comprise: receiving, by a core network using at least one first network function, a sensing request for a first object from a sensing client; determining, by the core network using at least one second network function, a first sensing device responding to the sensing request and a first user equipment (UE) capable of communicating with the first sensing device; and transmitting, by the core network using the at least one second network function, the sensing request to the first UE.

### CROSS-REFERENCE TO RELATED APPLICATIONS

This application claims priority to Korean Patent Applications No. 10-2024-0101843, filed on Jul. 31, 2024, and No. 10-2025-0104336, filed on Jul. 30, 2025, with the Korean Intellectual Property Office (KIPO), the entire contents of which are hereby incorporated by reference.

### BACKGROUND

### 1. Technical Field

The present disclosure relates to communication technology, and more particularly, to a technique for sensing a target object and providing corresponding sensing information through a communication network.

### 2. Related Art

The content described in this part merely provides background information on exemplary embodiments to be described and does not constitute prior art.

In a wireless communication network, electronic devices such as base stations (BS) and user equipments (UEs) communicate wirelessly to transmit and receive data. Sensing refers to a process of acquiring information on the surroundings of a device. It may also be used to detect various attributes of an object, such as its location, speed, distance, direction, shape, or texture. Such information may be utilized to enhance communication within the network and for other application-specific purposes.

Sensing in communication networks has typically been limited to active sensing techniques accompanied by devices that receive and process radio frequency (RF) sensing signals. Other sensing techniques, such as passive sensing (e.g. radar) and non-RF sensing (e.g. video imaging and other sensors), may address some limitations of active sensing. However, these other techniques are typically implemented as standalone systems separate from communication networks.

The 5G communication system has been designed with a focus on communication functions, and sensing technologies are performed in separate and independent systems. Sensing technologies independent of communication systems cause inefficient use of resources and act as major factors that degrade the reliability and quality of integrated sensing data. Therefore, improvements to address these issues are required.

### SUMMARY

The present disclosure has been derived to solve issues of the prior art, and the present disclosure is directed to providing network functions and procedures for implementing wireless signal-based sensing technology.

The present disclosure is directed to providing network functions and procedures for enhancing sensing services by utilizing wireless devices or sensing devices that are not able to directly use mobile communication services, as well as terminals capable of the mobile communication services within a mobile communication system.

The present disclosure is directed to providing network functions and procedures for enhancing sensing services by utilizing sensing based on various frequency bands and wireless technologies available outside a mobile communication system in a mobile communication network.

The present disclosure is directed to providing network functions and procedures for recognizing sensing devices of various wireless technologies or various frequency bands inside and outside a mobile communication system, and controlling or managing the sensing devices on a mobile communication network to enhance sensing services.

According to an exemplary embodiment of the present disclosure, a communication system providing object sensing may comprise at least one entity, and the at least one entity may comprise: a memory storing at least one computer-readable instruction; and a processor executing the at least one instruction.

The at least one entity may be configured to: receive, using at least one first network function within a core network, a sensing request for a first object from a sensing client; determine, using at least one second network function within the core network, a first sensing device responding to the sensing request and a first user equipment (UE) capable of communicating with the first sensing device; and transmit, using the at least one second network function, the sensing request to the first UE.

In a communication system according to an exemplary embodiment of the present disclosure, in the determining of the first sensing device and the first UE, the at least one entity may be configured to: determine the first sensing device and the first UE based on an information set for the first UE, the information set including information on the first sensing device participating in sensing for the first object and information on the associated first UE capable of communicating with the first sensing device through a communication technology different from a mobile communication technology corresponding to the core network.

In a communication system according to an exemplary embodiment of the present disclosure, in the determining of the first sensing device and the first UE, the at least one entity may be configured to: determine the first sensing device and the first UE based on an information set for the first object, the information set including information on the first sensing device participating in sensing for the first object and information on the associated first UE capable of communicating with the first sensing device through a communication technology different from a mobile communication technology corresponding to the core network.

In a communication system according to an exemplary embodiment of the present disclosure, the at least one entity may be configured to: receive, using the at least one second network function, sensing information of the first object corresponding to the sensing request; and update, using the at least one second network function, information on the first object, the first sensing device, or the first UE associated with the first sensing device based on the sensing information.

In a communication system according to an exemplary embodiment of the present disclosure, the at least one entity may be configured to: update, using the at least one second network function, information on the first object, the first sensing device, or the first UE associated with the first sensing device based on updated mobility information of the first object, the first sensing device, or the first UE associated with the first sensing device.

In a communication system according to an exemplary embodiment of the present disclosure, the at least one entity may be configured to: receive, using the at least one second network function, a detection result for the first object; and register, using the at least one second network function, information on the first object, the first sensing device capable of sensing the first object, and the associated first UE capable of communicating with the first sensing device as registration information corresponding to the first object, the first UE, or the sensing request, based on the detection result for the first object.

In this case, the registration information may include information on the associated first UE capable of communicating with the first sensing device through a communication technology different from a mobile communication technology corresponding to the core network.

In a communication system according to an exemplary embodiment of the present disclosure, the at least one entity may be configured to: receive, using the at least one second network function, sensing information of the first object corresponding to the sensing request; and update, using the at least one second network function, the registration information based on the sensing information.

In a communication system according to an exemplary embodiment of the present disclosure, the at least one entity may be configured to: update, using the at least one second network function, the registration information based on updated mobility information of the first object, the first sensing device, or the first UE associated with the first sensing device.

In a communication system according to an exemplary embodiment of the present disclosure, the at least one entity may be configured to: retrieve, using the at least one second network function, information of the first sensing device and the first UE responding to the sensing request from a unified data management (UDM) or a unified data repository (UDR).

According to an exemplary embodiment of the present disclosure, an object sensing method using a mobile communication network may comprise: receiving, by a core network using at least one first network function, a sensing request for a first object from a sensing client; determining, by the core network using at least one second network function, a first sensing device responding to the sensing request and a first user equipment (UE) capable of communicating with the first sensing device; and transmitting, by the core network using the at least one second network function, the sensing request to the first UE.

In the determining of the first sensing device and the first UE, the first sensing device and the first UE may be determined based on an information set for the first UE, the information set including information on the first sensing device participating in sensing for the first object and information on the associated first UE capable of communicating with the first sensing device through a communication technology different from a mobile communication technology corresponding to the core network.

In the determining of the first sensing device and the first UE, the first sensing device and the first UE may be determined based on an information set for the first object, the information set including information on the first sensing device participating in sensing for the first object and information on the associated first UE capable of communicating with the first sensing device through a communication technology different from a mobile communication technology corresponding to the core network.

According to an exemplary embodiment of the present disclosure, the object sensing method using a mobile communication network may further comprise: receiving, by the core network using the at least one second network function, sensing information of the first object corresponding to the sensing request; and updating, by the core network using the at least one second network function, information on the first object, the first sensing device, or the first UE associated with the first sensing device based on the sensing information.

According to an exemplary embodiment of the present disclosure, the object sensing method using a mobile communication network may further comprise: updating, by the core network using the at least one second network function, information on the first object, the first sensing device, or the first UE associated with the first sensing device based on updated mobility information of the first object, the first sensing device, or the first UE associated with the first sensing device.

According to another exemplary embodiment of the present disclosure, an object sensing method using a mobile communication network may comprise: receiving, by a core network using at least one second network function, a detection result for a first object corresponding to a sensing request received from a sensing client via at least one first network function; and registering, by the core network using the at least one second network function, information on the first object, a first sensing device capable of sensing the first object, and an associated first user equipment (UE) capable of communicating with the first sensing device as registration information corresponding to the first object, the first UE, or the sensing request, based on the detection result for the first object.

In the object sensing method using a mobile communication network, according to another exemplary embodiment of the present disclosure, the registration information may include information on the associated first UE capable of communicating with the first sensing device through a communication technology different from a mobile communication technology corresponding to the core network.

According to another exemplary embodiment of the present disclosure, the object sensing method using a mobile communication network may further comprise: receiving, by the core network using the at least one second network function, sensing information of the first object corresponding to the sensing request; and updating, by the core network using the at least one second network function, the registration information based on the sensing information.

According to another exemplary embodiment of the present disclosure, the object sensing method using a mobile communication network may further comprise: updating, by the core network using the at least one second network function, the registration information based on updated mobility information of the first object, the first sensing device, or the first UE associated with the first sensing device.

According to another exemplary embodiment of the present disclosure, the object sensing method using a mobile communication network may further comprise: receiving, by the core network using the at least one first network function, a monitoring request for the first object; determining, by the core network using the at least one second network function, the first sensing device and the first UE responding to the monitoring request based on the registration information; and transmitting, by the core network using the at least one second network function, the sensing request to the first UE. According to exemplary embodiments of the present disclosure, network functions and procedures for implementing wireless signal-based sensing technology can be implemented.

According to exemplary embodiments of the present disclosure, network functions and procedures for enhancing sensing services by utilizing wireless devices or sensing devices that are not ale to directly use mobile communication services within a mobile communication system can be implemented.

According to exemplary embodiments of the present disclosure, network functions and procedures for enhancing sensing services by utilizing sensing based on various frequency bands and wireless technologies available outside a mobile communication system through a mobile communication network can be implemented.

According to exemplary embodiments of the present disclosure, network functions and procedures for recognizing sensing devices of various wireless technologies or various frequency bands outside a mobile communication system, controlling or managing the sensing devices on a mobile communication network, and enhancing sensing services can be implemented.

### BRIEF DESCRIPTION OF DRAWINGS

FIG. 1 is a diagram conceptually illustrating a wireless signal-based sensing service for recognizing a wireless sensing UE according to an exemplary embodiment of the present disclosure and a core network supporting the service.

FIG. 2 is a diagram conceptually illustrating an architecture of the core network of FIG. 1.

FIG. 3 and FIG. 4 are operation flowcharts illustrating exemplary embodiments of a process for detecting and monitoring objects for an object sensing method according to an exemplary embodiment of the present disclosure.

FIG. 5 to FIG. 8 are operation flowcharts illustrating exemplary embodiments of processes of updating information of target objects, sensing devices, and/or associated UEs and performing actual sensing for an object sensing method according to an exemplary embodiment of the present disclosure.

FIG. 9 is an operation flowchart illustrating exemplary embodiments of processes of handling sensing requests and determining sensing devices and/or associated UEs responding to sensing requests for an object sensing method according to an exemplary embodiment of the present disclosure.

FIG. 10 is an operation flowchart illustrating exemplary embodiments of a process for registering and/or updating sensing registration information for an object sensing method according to an exemplary embodiment of the present disclosure.

FIG. 11 is a conceptual diagram illustrating an example of a generalized computing system in which an entity within the core network 200 capable of performing at least a portion of the processes of FIGS. 1 to 10, a sensing entity participating in the sensing process in interaction with the core network, or a part thereof may be implemented.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Meanwhile, even if a technology is known prior to the filing date of the present disclosure, it may be included as part of the configuration of the present disclosure when necessary, and will be described herein without obscuring the spirit of the present disclosure. However, in describing the configuration of the present disclosure, a detailed description on matters that can be clearly understood by those skilled in the art as a known technology prior to the filing date of the present disclosure may obscure the purpose of the present disclosure, so excessively detailed description on the known technology will be omitted.

However, the purpose of the disclosure is not to claim the rights to these known technologies, and the contents of the known technologies may be included as part of the disclosure without departing from the scope of the disclosure.

Hereinafter, exemplary embodiments of the disclosure will be described in more detail with reference to the accompanying drawings. To facilitate an overall understanding in the description of the disclosure, the same reference numerals will be assigned to the same components throughout the accompanying drawings, and redundant descriptions thereof will be omitted.

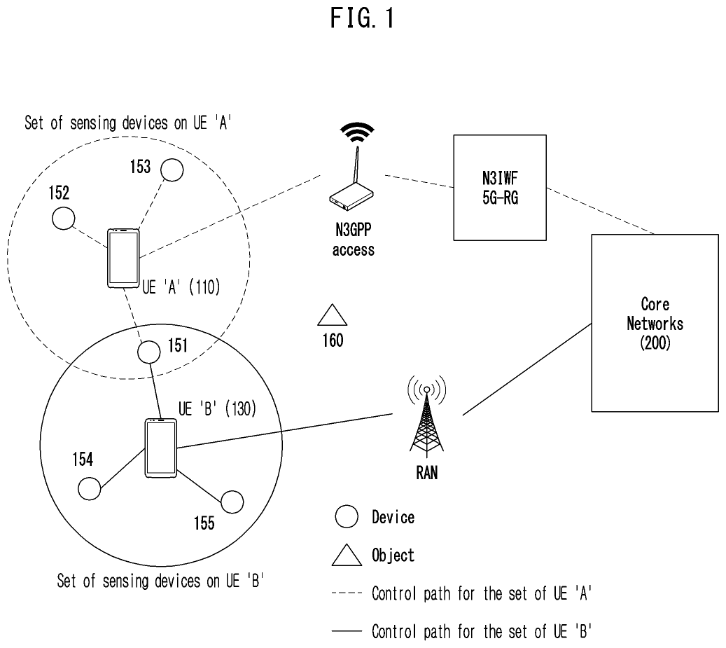

FIG. 1 is a diagram conceptually illustrating a wireless signal-based sensing service for recognizing a wireless sensing UE according to an exemplary embodiment of the present disclosure and a core network 200 supporting the service.

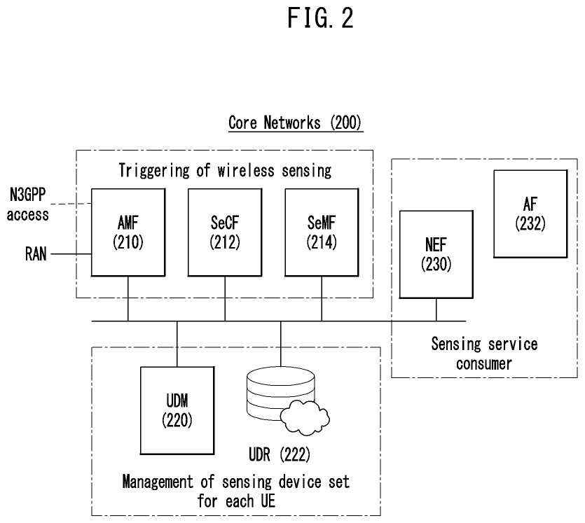

FIG. 2 is a diagram conceptually illustrating an architecture of the core network 200 of FIG. 1.

For implementation and operations of the exemplary embodiments of FIG. 1 and FIG. 2, at least a part of integrated sensing and communication technology may be used within a range not contrary to purposes of the present disclosure.

Referring to FIG. 1, FIG. 2, and FIG. 11 described later, each of entities within the core network 200 and/or sensing entities related to a sensing process by the wireless signal-based sensing service, according to an exemplary embodiment of the present disclosure, may include a memory 1200 storing at least one computer-readable instruction and a processor 1100 executing at least one instruction.

The core network 200 may include various network functions (NFs). Referring collectively to the functions illustrated in FIG. 1 or FIG. 2 as well as functions not illustrated, the core network 200 may include an Application Function (AF) 232, an Access and Mobility management Function (AMF) 210, an Application Service Provider (ASP), a Location Management Function (LMF), a Network Exposure Function (NEF) 230, Operation, Administration, and Maintenance (OAM), a Session Management Function (SMF), a Policy Control Function (PCF), a Unified Data Management (UDM) 220, a Unified Data Repository (UDR) 222, a Data Network (DN) or a local part of DN enabling local access to the data network, a User Plane Function (UPF), a (Radio) Access Network ((R)AN), and a User Equipment (UE).

A part of functions of the ASP may be a part of an NF of the core network 200, and a part of the functions of the ASP may be provided to a user by being implemented in the form of a sensing client.

In an alternative exemplary embodiment of the present disclosure, the sensing client may include an ASP using a sensing service of a mobile communication network. In an alternative exemplary embodiment of the present disclosure, the sensing client may include an ASP and an ASP implementation service in the form of an application executed in a UE environment.

The sensing client may have a part of its functions implemented in the form of an application (App) in the UE and communicate with the UE, and may communicate with the core network via a first NF. In this case, the sensing client may include an ASP NF.

In this case, the respective NFs may support the following functions.

The AMF 210 may provide functions for access and mobility management per UE, and one service executed in the UE may be connected to one AMF 210 as a basic configuration.

For example, the DN may refer to an operator service, Internet access, or a third-party service. The DN may transmit downlink protocol data units (PDUs) to the UPF or receive, from the UPF, PDUs transmitted from the UE. The local part of DN may refer to a data network that allows local access to the DN and has a short data transmission path. The local part of DN may be used to refer to a DN in which edge application servers supporting edge computing services are deployed.

The PCF may provide functions of determining policies for mobility management, session management, etc. for each service by receiving information on a service-specific packet flow from an application server. Specifically, the PCF may support a unified policy framework for controlling network operations, provide policy rules so that control plane function(s) (e.g. AMF, SMF, etc.) can enforce the policy rules, and implement a front end for accessing subscription information related to policy decisions within the UDR.

The SMF may provide session management functions, and when the UE has multiple sessions, each session may be managed by a different SMF.

The UDM 220 may store UE subscription data, policy data, information on services used by the UE, and information on NFs serving the UE in the UDR 222 or may provide the information to other NFs.

The UDR 222 may provide, to other NFs, services of storing, deleting, updating, and retrieving UE subscription data, policy data applicable to services used by the UE, device configuration information for UE services, and service rule information.

The UPF may deliver downlink PDUs received from the DN to the UE via the (R)AN, and may deliver uplink PDUs received from the UE via the (R)AN to the DN. An uplink classifier (ULCL) may refer to a UPF having functions of performing uplink classification and transmissions. A local UPF (L-UPF) may perform a role of a PDU session anchor of sessions transmitted to the local part of DN.

A Sensing Network Function (SNF) may be an NF adopting a part of an NF supporting ISAC services. The SNF may perform at least one operation of receiving an ISAC service request, performing authentication for the request, generating and configuring an ISAC service quality control policy, discovering and selecting network device(s) and UE(s) performing a sensing operation, and collecting and processing sensing results. The operations may be configured or implemented as two logically separated NFs, a Sensing Service Gateway/Centre and a Sensing Management Function.

For example, when configured/implemented as logically separated NFs, the Sensing Service Gateway/Centre may be deployed in the mobile communication core network and may perform operations such as receiving an ISAC service request, performing authentication, and generating an ISAC service quality control policy, and the Sensing Management Function may be deployed in the mobile communication core network and may perform operations such as discovering and selecting NFs and UEs for actual sensing operation and collecting and processing sensing results. The present disclosure does not limit a method of configuring the SNF, and both an exemplary embodiment in which the functions are integrated into one and operate and an exemplary embodiment in which the functions operate separately are included in the scope of the present disclosure. In an exemplary embodiment of the present disclosure, at least a part of the functions of the Sensing Service Gateway/Centre and the Sensing Management Function may be included in functions of a Sensing Capability Exposure Function (SCEF), and/or a Sensing Service Provisioning Function (SePF), and/or a Sensing Entity Control Function (SeCF), and/or a Sensing Result Calculation Function (SeCF), and/or a Sensing Service Provisioning Function (SePF).

In the case of the UE, the UE may be included in exemplary embodiments of the present disclosure as a UE requesting an actual ISAC service, or may be included in exemplary embodiments of the present disclosure as a UE performing a role of a sensor detecting a sensing object to provide an ISAC service to the wireless communication system.

The base station constituting the (R)AN may not only transmit and receive signals for communication but also perform an operation of detecting a sensing object as a sensor.

For quality control of the ISAC service according to exemplary embodiments of the present disclosure, ISAC service quality-related information may be used in the wireless communication system and in an external ISAC service requesting device. For description of exemplary embodiments described later, the ISAC service quality-related information may be referred to as sensing service quality (SSQ).

Referring again to FIG. 1 and FIG. 2, the core network 200 according to an exemplary embodiment of the present disclosure may communicate with at least one entity connected to a sensing apparatus or a sensing device capable of sensing a sensing object (or target). In this case, the sensing apparatus or the sensing device may be a separate device from the UE or gNB, or may be the UE or the gNB.

The core network 200 may control, manage, or provide configuration information for sensing devices and entities connected to sensing devices or functioning as sensing devices.

The core network 200 may receive sensing data obtained by sensing devices via entities connected to the sensing devices or functioning as sensing devices.

The core network 200 may include an SeCF 212, an SeMF 214, an SeRF, and an SePF.

The core network 200 may provide sensing results obtained using the SeCF 212, the SeMF 214, the SeRF, and the SePF to an application.

The core network 200 may provide AI/ML, network storage, edge computing, and/or multi-access functionalities using the SeCF 212, the SeMF 214, the SeRF, and the SePF.

In the present disclosure, the term ‘sensing entity’ may refer to, for convenience of description, an entity connected to or constituting a sensing device and capable of communicating with the core network 200. The sensing entity may be a device separate from the sensing device or the sensing device itself having a sensing functionality.

The sensing entity may be an entity within the (R)AN. The sensing entity may generally be a 3GPP-or 5G-based entity and may also be a non-3GPP entity.

The sensing entity may generally be deployed in a terrestrial communication network, but the sensing entity may also exist in aerial or satellite communication networks.

The sensing entity may transmit sensing information on a sensing object or sensing target to the core network 200 (or to an entity within the core network 200). In this case, if the sensing device is arranged separately from the sensing entity, sensing information from the sensing device may be delivered to the core network 200 via the sensing entity. If the sensing device has a sensing functionality, sensing information obtained by a sensor module implementing the sensing functionality may be transmitted to the core network 200 via a communication module of the sensing entity.

In addition, the core network 200 (or an entity within the core network 200) may control or manage a sensing process performed by the sensing entity based on the architecture illustrated in FIGS. 1 and 2. The sensing entity may include a UE or a gNB, and the core network 200 (or an entity within the core network 200) may control or manage the sensing entity to transmit and receive wireless signals for sensing.

The core network 200 (or an entity within the core network 200) may acquire or receive sensing information for the sensing target by cooperating with the sensing entity or utilizing the sensing entity based on the architecture illustrated in FIG. 1.

The sensing entity/equipment/device in a 3GPP network may be a gNB or UE. A non-3GPP sensing device may be a LiDAR, laser, imaging sensor, temperature sensor, or the like using radio access techniques (e.g. WiFi, Bluetooth, etc.) which are not defined by the 3GPP.

In the case where the sensing entity is a gNB or UE in the 3GPP network, wireless signals for sensing the sensing target may use 5G NR or 6G radio access techniques. However, the spirit of the present disclosure is not limited by such an exemplary embodiment.

Referring again to FIGS. 1 and 2, when the sensing entity within the RAN receives the sensing reference signals, the sensing entity may deliver sensing data to the core network 200. The core network 200 may process the sensing data received from the sensing entity.

The core network 200 may calculate a sensing result based on the sensing data.

The core network 200 may expose the sensing result.

The core network 200 may provide the sensing result.

The core network 200 according to an exemplary embodiment of the present disclosure may include the following NFs and procedures.

The core network 200 in the exemplary embodiments of FIG. 1 and FIG. 2 may include the SeCF 212, the SeMF 214, the SeRF, and the SePF as sensing service-related NFs. These NFs are core components for efficiently performing control, processing, calculation, and exposure of sensing data.

The SeCF 212 may define and control the configuration of the sensing entity, the SeMF 214 may collect and pre-process data, the SeRF may analyze the data to generate a result, and the SePF may provide the result to the service. The respective NFs may interact through messages and procedures to manage sensing data in an integrated manner.

The roles of the SeCF 212 are as follows.

The SeCF 212 may perform configuration and control on the sensing entity. The SeCF 212 may manage a configuration between the sensing entity and the sensing device and may configure the sensing entity and the sensing device in association.

Sensing device control and policy configuration: The SeCF 212 may perform detailed configuration of the sensing device operations in terms of time, space, and range, and may define management and sharing policies.

Sensing device selection: The SeCF 212 may select a device or a device group that is to perform transmission and reception of sensing signals. The SeCF 212 may search for and select a sensing entity associated with the sensing device or device group.

The roles of the SeMF 214 are as follows.

The SeMF 214 may perform collection, coordination, processing, and quality of service (QoS) management of the sensing data. The SeMF 214 may comprehensively manage storage and provision of the sensing data.

The SeMF 214 may instruct the sensing entity to perform a sensing operation and may coordinate and manage the sensing operation.

Sensing control flow management: The SeMF 214 may comprehensively manage the sensing control and operation invocation.

Sensing data management: The SeMF 214 may store, manage, and provide sensing data (including raw data), and may evaluate and manage the accuracy and response time of the data. The SeMF 214 may collect and coordinate the sensing data and may manage the quality of the sensing data based on QoS.

Sensing method selection: The SeMF 214 may map a sensing target object and a sensing space and may select an optimal sensing method for the sensing target object and the sensing space.

The roles of the SeRF are as follows.

Sensing result calculation: The SeRF may process sensing data and derive a result by applying filtering and mapping.

Result validity evaluation: The SeRF may validate the sensing result and manage a quality of the result. In this case, the SeRF may evaluate and manage the accuracy and response time of the sensing result for quality management.

The roles of the SePF 140 as follows.

The SePF may manage a service request and monitor event condition(s) included in the service request.

The SePF may map the sensing result according to the service request and perform authentication and authorization for the service request.

Service request and authentication: The SePF may manage the service request and authenticate and authorize the corresponding request.

Sensing data exposure: The SePF may map the service request and the sensing result and provide them to an application service while maintaining security. The SePF may maintain the security of the sensing data and sensing result and manage privacy.

The SeCF 212 and/or the SeMF 214 may generate a sensing trigger based on the sensing request, and transmit the sensing trigger to a non-3GPP (N3GPP) access network or the RAN via the AMF 210.

In this case, the sensing trigger may include a request for configuration information of sensing devices/sensing entities held by the SeCF 212 and/or the SeMF 214.

The SeCF 212 may communicate with sensing entities within the RAN via the AMF 210. The configuration information held by the SeCF 212 may be delivered to the sensing entities within the RAN. The information delivered in this case may include sensing configuration/policy information and registration information of sensing equipments. The information delivered in this case may be configuration information that enables at least one sensing entity to sense a sensing target.

In this case, the UPF may also deliver a part of the sensing data to the SeCF 212 and/or the SeMF 214.

The SeCF 212 and/or the SeMF 214 may deliver the sensing data to the SeRF, and the SeRF may calculate a sensing result based on the sensing data and provide the sensing result to the SeCF 212 and/or the SeMF 214.

The sensing result may be delivered from the SeCF 212 and the SeMF 214 to the SePF. The sensing result may be provided to the application side via the SePF, the SCEF, the NEF 230, and the AF 232.

The SeCF 212 and/or the SeMF 214 may select an infrastructure (sensing devices) that will transmit sensing wireless signals and control and configure operations of the sensing devices.

The SeCF 212 and the SeMF 214 may collect, store, and transmit the measured sensing data.

The SeRF may calculate the collected sensing data and generate the sensing result as a result of the calculation. The SeRF may inspect the sensing result and manage a quality of the sensing result.

The SePF may invoke or manage sensing-related integrated services. The SePF may also provide the sensing result to an external application.

In an alternative exemplary embodiment of the present disclosure, the core network may further include a Network Data Analytics Function (NWDAF). The NWDAF may support AI-based analysis. The NWDAF may support preprocessing of sensing data, optimization of device configuration, and enhancement of result calculation efficiency by utilizing AI algorithms.

The NWDAF may analyze data provided by a sensing entity to generate QoS improvement information. The QoS improvement information may be delivered to the SeCF 212, SeMF 214, and/or the SeRF to enhance the efficiency of data processing and result calculation.

The UE may be a client of a sensing application requesting sensing or may be a sensing entity that participates in sensing to perform the sensing operation corresponding to the sensing request. The UE may participate in sensing for the sensing service that the UE has requested. In this case, the UE may be located within a specific target area designated by the sensing request. The UE may participate in sensing for a sensing service requested by another UE and may provide a sensing measurement result.

The sensing client may include the ASP. The sensing client may receive a sensing request from the UE (S310). In this case, the UE may be a client of the sensing application requesting sensing.

The UE, as a sensing entity, may transmit either processed measurement (e.g. an event inferred from measured data such as movement of a sensing target exceeding a certain range or a shape of the sensing target) or unprocessed measurement (e.g. measured raw data) to the sensing client.

The sensing client may include a sensing measurement analyzer or may interact with the sensing measurement analyzer to process the sensing measurement. For example, the ASP of the sensing client may deliver a set of processed/unprocessed measurements to the sensing measurement analyzer, and the sensing measurement analyzer may deliver an analysis result to the first NF (e.g. application interface NF within the core network 200) directly, or to an application layer of UE via the first NF and/or the UPF. If the UE is a client of the application or service, the analysis result may be delivered to the UE.

The sensing measurement analyzer may also be implemented through NF(s) within the core network other than the sensing client. For example, the SeCF 212, the SeMF 214, and/or the SeRF may include the sensing measurement analyzer function.

Further, the NWDAF within the core network 200 may be used to assist or complement the function of the sensing measurement analyzer.

The UE and the RAN may include sensing reference signal transmitter (Tx)/receiver (Rx) modules. The RAN may use various access techniques such as Wi-Fi, New Radio (NR), E-UTRA, and 6G radio to transmit and/or receive sensing reference signals according to the sensing policy delivered from the PCF.

When the UE transmits a sensing reference signal, the transmitting UE may perform transmission and/or reception of the sensing reference signal according to the sensing policy delivered from the PCF by utilizing various access technologies, similarly to the RAN, with respect to a receiving UE. The RAN and the UE may include sensing signal analyzers/transporters. The sensing signal analyzers/transporters may derive meaningful results corresponding to the request from the sensing application or may provide raw measurements to the ASP of the sensing client. The sensing results may be delivered directly via a user plane or via a control plane of the core network, such as the SeCF 212, the SeMF 214, and/or the SCEF.

The sensing client function may include a sensing measurement analyzer and an ASP (server). The sensing measurement analyzer may analyze both processed measurements and unprocessed measurements among the collected sensing measurements.

The ASP (server) may perform two roles: initiating negotiation to implement sensing activities in the cellular network and supporting transmission of sensing measurements from the cellular network to the sensing measurement analyzer.

The first NF (e.g. SePF, AF 232, NEF 230, and/or SCEF) may perform two roles. First, the first NF may convert an external request into a cellular network service request, and second, the first NF may store the sensing request and transfer the sensing request to the second NF (e.g. UDM 220 and/or UDR 222) by tagging specific requirements expressed by the sensing client.

Through the interaction of these NFs, the core network 200 may integrally manage processes of request, control, processing, calculation, exposure, and response of sensing data. For this purpose, the NFs may interact through messages and procedures. The core network 200 according to an exemplary embodiment of the present disclosure may overcome limitations of the 5G system and maximize the efficiency of ISAC technology.

Referring again to FIG. 2, the core network 200 may receive a sensing request from an application/sensing service side. In this case, an NF performing an interface role with the application/sensing service side may include the AF 232, NEF 230, SePF, and/or a sensing capability exposure function (SCEF). The AF 232, NEF 230, SePF, and/or SCEF may be implemented as sensing service consumers.

For convenience of description, NFs operating as sensing service consumers are referred to as first NFs.

At least one first NF may receive the sensing request from the sensing client and may provide the sensing client with a sensing result obtained based on a processing result within the core network 200.

The core network 200 may control a sensing entity within the RAN to transmit a sensing reference signal for sensing a sensing object (target) within a sensing space. Such roles may be performed by the AMF 210, SeCF 212, and SeMF 214 illustrated in FIG. 2. These NFs may trigger wireless sensing and may control or manage UEs associated with sensing.

In addition to the NFs illustrated in FIG. 2, the PCF, SeRF, and/or SePF may also be involved in procedures for triggering wireless sensing and controlling or managing associated UEs.

Such NFs that trigger wireless sensing and control or manage associated UEs may be referred to as second NFs for convenience of description.

The UDM 220 and/or UDR 222 may manage and store sensing device sets for respective UEs. The UDM 220 and/or UDR 222, according to an exemplary embodiment of the present disclosure, may belong to the second NF or may operate by a request of the second NF.

The operations of the core network 200 may be performed by various NFs within the core network 200 as described above. These NFs may be performed by at least one entity within the core network 200, may be performed through cooperation of two or more entities, or may be performed by allocating individual NFs to individual entities. The spirit of the present disclosure is not limited by hardware implementation of such NFs within the core network 200.

Referring to FIG. 1, FIG. 2, and FIG. 11 to be described later, a communication system providing a reservation-based sensing function according to an exemplary embodiment of the present disclosure may include at least one entity, and the at least one entity may include a memory 1200 storing at least one computer-readable instruction and a processor 1100 executing the at least one instruction.

The at least one entity may receive a sensing request for a first object from a sensing client by using at least one first NF within the core network, may determine a first sensing device corresponding to the sensing request and a first UE communicable with the first sensing device by using at least one second NF within the core network, and may transmit the sensing request to the first UE by using the at least one second NF.

In this case, the at least one first NF may be an NF interfacing with the sensing client (or ASP server), such as the SCEF, AF 232, NEF 230, and/or SePF.

The at least one second NF may be an NF storing, processing, managing, calculating, and controlling UE or object information, such as AMF 210, SeCF 212, SeMF 214, PCF, UDM 220, UDR 222, SePF, and SeRF.

In a communication system according to an exemplary embodiment of the present disclosure, when determining the first sensing device and the first UE, the at least one entity may determine the first sensing device and the first UE based on an information set for the first UE that includes information on the first sensing device participating in sensing for the first object and information on the associated first UE that is communicable with the first sensing device by using a communication technology different from a mobile communication technology corresponding to the core network.

In a communication system according to an exemplary embodiment of the present disclosure, when determining the first sensing device and the first UE, the at least one entity may determine the first sensing device and the first UE based on an information set for the first object that includes information on the first sensing device participating in sensing for the first object and information on the associated first UE that is communicable with the first sensing device by using a communication technology different from a mobile communication technology corresponding to the core network.

The information on the first object as a target object or information on the first UE associated with the first sensing device capable of sensing the first object may be managed as UE subscription information.

Alternatively, when set information including the target object, the sensing device, and the associated UE is managed for a specific object, the set information may be generated and managed as an object profile.

Alternatively, the set information may be generated and managed for a specific sensing event or application. In the case of a sensing event, the set information may be managed in association with a subscription permanent identification (SUPI) or GPSI of the first UE, and in the case of management by application, the set information may be managed in association with an application ID used by the first UE.

The UE subscription information, SUPI or GPSI information, or application ID-associated information may include set information as follows.

The set information, which is configured and managed in object sensing provided in a communication system according to an exemplary embodiment of the present disclosure, may include a UE identifier such as SUPI or GPSI of the first UE, a sensing device identifier accessible via the first UE (indication of a subset of UEs), a specific area detectable via the first UE, an object type (e.g. person, vehicle, unmanned aerial system, industrial machine, robot, wireless device, etc.) detectable via the first UE and the first sensing device, a subscription correlation ID and object ID currently provided through the first UE and the first sensing device, a user identity profile of the first UE, an application ID used by the first UE, and the like.

In a communication system according to an exemplary embodiment of the present disclosure, the at least one entity may receive sensing information of the first object corresponding to the sensing request by using the at least one second NF and may update information on the first object, the first sensing device, or the first UE associated with the first sensing device based on the sensing information by using the at least one second NF.

In a communication system according to an exemplary embodiment of the present disclosure, the at least one entity may update information on the first object, the first sensing device, or the first UE associated with the first sensing device, based on updated mobility information of the first object, the first sensing device, or the first UE associated with the first sensing device by using the at least one second NF.

In a communication system according to an exemplary embodiment of the present disclosure, the at least one entity may receive a detection result of the first object by using at least one second NF, and based on the detection result of the first object, the at least one entity may register information of the first object, the first sensing device capable of sensing the first object, and the associated first UE communicable with the first sensing device as registration information corresponding to the first object, the first UE, or the sensing request by using the at least one second NF.

In this case, the registration information may include information on the associated first UE communicable with the first sensing device by using a communication technology different from a mobile communication technology corresponding to the core network.

In a communication system according to an exemplary embodiment of the present disclosure, the at least one entity may receive sensing information of the first object corresponding to the sensing request by using the at least one second NF and may update the registration information based on the sensing information by using the at least one second NF.

In a communication system according to an exemplary embodiment of the present disclosure, the at least one entity may update the registration information based on updated mobility information of the first object, the first sensing device, or the first UE associated with the first sensing device by using the at least one second NF.

In a communication system according to an exemplary embodiment of the present disclosure, the at least one entity may retrieve information of the first sensing device and the first UE corresponding to the sensing request from the UDM or UDR by using the at least one second NF.

Referring to exemplary embodiments of FIG. 1 to FIG. 11 described later, methods may be proposed for: controlling devices, each having respective wireless technologies, to utilize various frequency bands and wireless technologies available in wireless devices (e.g. UEs) registered with a mobile communication system operator and capable of directly using mobile communication services, wireless devices unregistered with the operator and incapable of directly using such services, mobile communication base stations, and other wireless technology access points (APs) (e.g. WiFi APs) in a mobile communication network; recognizing the state of an object by collecting wireless measurement information generated in multiple bands; and providing a system architecture therefor.

The present disclosure proposes a) a method and structure of recognizing other wireless technologies of a terminal outside a mobile communication frequency band technology in a mobile communication system and controlling the wireless technologies in a mobile communication network, b) a method of collectively processing object state-related information generated in a frequency band outside mobile communication and object state-related information generated in a mobile communication band, and/or c) a method of recognizing and responding in a mobile communication network to changes in a system caused by movement of a mobile communication terminal and changes in object state-related wireless measurement data.

According to an exemplary embodiment of the present disclosure, object state information may be measured by controlling other wireless technologies and frequency bands outside a mobile communication frequency band, and accuracy of recognizing object states through a mobile communication system can be improved.

Due to an increasing amount of data and a need to support low-latency communication, an industrial demand for wider frequency bands in a communication system is steadily increasing. This industrial demand may lead to an expansion/increase of digital communication frequencies through innovative wireless technologies.

When higher frequencies are utilized for communication, sensitivity along a wireless signal path or trajectory may increase, thereby providing an opportunity to detect an object and attributes of the object (e.g. mobility, shape, location) within the signal path.

A current cellular system is limited to controlling only a device equipped with a universal subscriber identity module (USIM) and an access point compliant with 3GPP standards. This limitation may cause difficulties in implementing a wireless signal-based object sensing service.

The present disclosure proposes a comprehensive solution for implementing a sensing service through a cellular system by utilizing various wireless communication signals of various technologies such as WiFi, LTE, NR, Bluetooth, and UWB. The present disclosure proposes the following three features: (a) an architecture designed to manage control for various frequency bands and wireless technologies (including a non-USIM-based device and a device not defined in 3GPP standards), (b) an inference method of evaluating a state of an object by using signal measurements of multiple frequency bands, devices, and access points, and (c) a technique of detecting mobility of an object and a device and mitigating an influence due to the mobility.

Referring to FIG. 1 and FIG. 2, with respect to the feature (a) above, an architecture designed to facilitate control for various frequency bands and wireless technologies (including a non-USIM-based device and a technology not defined by 3GPP) is illustrated.

The present disclosure proposes a framework enabling interaction between a mobile communication operator and a device not subscribed to a cellular system. As illustrated in FIG. 1 and FIG. 2, interaction between a cellular network and an ASP may be defined.

FIG. 1 and FIG. 2 illustrate an example of a cellular system architecture designed to discover and/or recognize and control a sensing device that is not capable of communicating through a standard cellular frequency band and technology.

Each first UE may be associated with a set of first sensing devices, and the set may include a first object detected via a device or a UE within the set. For example, in FIG. 1, a set associated with a UE ‘B’ 130 may include sensing devices 151, 154, and 155 and an object 160 detectable via the sensing devices. The cellular core network 200 may store this set information for each UE within NF(s) such as UDM 220 and UDR 222.

A UE ‘A’ 110 may be associated with sensing devices 151, 152, and 153, and the sensing devices may be included in a management scheme of the core network 200 through non-3GPP access. In this case, the core network 200 may access the set of sensing devices connected to the UE ‘A’ 110 via a non-3GPP interworking function (N3IWF). The N3IWF serves as a gateway for connecting to the 5G core network 200 via a non-3GPP network (e.g. Wi-Fi) in the 5G core network 200, and detailed description thereof is omitted in the present disclosure.

When there is a sensing request for a target object 160, the sensing device 151 closest to the target object 160 may generate sensing information for the object 160. In this case, the sensing device 151 may be included in and managed by a device set of the UE ‘B’ 130 via the RAN. In this case, the UE ‘B’ 130 may be designated as an associated UE of the target object 160 and the sensing device 151. In this case, information on the target object 160, the sensing device 151 to participate in sensing, and the associated UE ‘B’ 130 may be generated as set information and may be stored in the UDM 220 or UDR 222 within the core network 200.

When the UE ‘B’ 130 moves away from the sensing device 151, mobility information of the UE ‘B’ 130 may be updated, and the core network 200 may newly designate the UE ‘A’ 110 as an associated UE to participate in sensing for the target object 160. In this case, information on the target object 160, the sensing device 151 to participate in sensing, and the associated UE ‘A’ 110 may be stored as new/updated set information in the UDM 220 or UDR 222 within the core network 200.

Alternatively, even when the object 160 moves away from the sensing device 151 and becomes close to the sensing device 153, mobility information of the UE ‘B’ 130 and UE ‘A’ 110 may be updated, and the core network 200 may newly designate the sensing device 153 to participate in sensing for the target object 160 and the UE ‘A’ 110 as an associated UE.

Since each of the UE, the sensing device, and the object may have mobility, even when the sensing device moves, mobility information of the UE may be updated, and the core network 200 may designate a new sensing device and an associated UE to participate in sensing for the target object 160 and may update related set information.

Two methods of storing and registering set information in the cellular network may be proposed. A first method is a method in which a UE performs a process of storing and registering set information, and a second method may be a method in which the AF 232 performs the process.

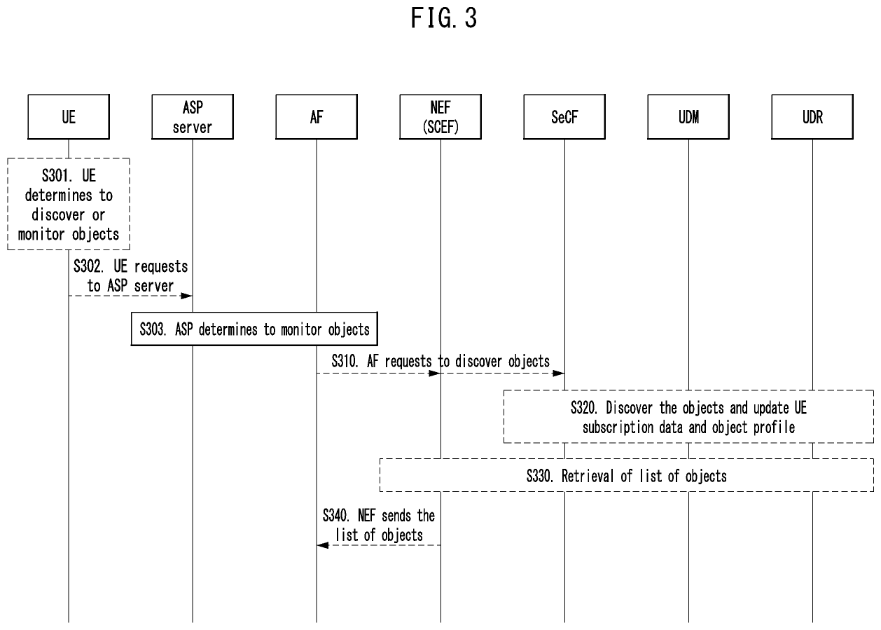

Examples of the two methods are described in detail in FIGS. 3 to 8 to be described later. Through the stored sensing set information, the cellular network system may identify an appropriate sensing set for each sensing request of a sensing service consumer.

A sensing device may communicate with a UE through a wireless channel and may have at least one sensing capability corresponding to a relevant technology. The present disclosure considers a case where the sensing device is not capable of directly interacting with the cellular network. For example, the sensing devices may include non-subscribers and devices incapable of using a cellular frequency and technology.

Since a communication capability of the sensing device is limited, an associated UE within a set may serve as a mediator to enable the cellular network system to control sensing at the sensing device. In this case, a condition that the UE is able to establish a data communication link to the sensing device may be assumed.

When the cellular network system decides to trigger sensing using a device, the cellular network system may identify a UE associated with the device via the UDM 220 and UDR 222 and may transmit a signal or a UE policy/configuration update to activate sensing.

Upon receiving the signal, the UE may activate sensing at the sensing device through a direct communication channel according to an indication of the cellular network and/or configured information of a sensing application implemented in a UE App.

An object detected/detectable via the UE may be registered in the UDM 220 and UDR 222 as a part of a UE's set. When a sensing device within the set or the UE detects the object, the UE may register the detected object in the UDM 220 and UDR 222 as an element of the UE's set. Upon a re-requested sensing for monitoring of the detected object, the cellular network may recognize a location of the object and a reachable UE based on already-registered set information.

Since the object, the sensing device, and the UE may have mobility, the UE may dynamically update the UE's set information (e.g. set elements) to the cellular network. Due to mobility and a possibility of a communication channel loss, the set does not guarantee a state of the UE. If the cellular network fails to activate and locate a sensing device or an object within the set via the UE, the cellular network may update the set elements in the UDM 220 and UDR 222 to remove the failed device or object from the set.

The sensing service consumer NF may include the AF 232 and NEF 230. In addition, the SCEF or SePF not illustrated may be included in the sensing service consumer NF.

In the exemplary embodiment of FIG. 2, the AF 232 may be directly connected to the ASP and may provide APIs related to sensing services to the ASP. When the ASP triggers sensing via the AF 232, the NEF 230 may convert the sensing request into internal cellular network APIs and may invoke operations of related NFs (e.g. SeCF 212 and SeMF 214) to activate sensing.

The ASP may decide to trigger sensing for various reasons, including a request from a UE or a device using an ASP service. The UE and the device may have a sensing App from the ASP, and may have configuration information of the ASP in its firmware or OS. According to configuration or manual initiation, the UE or the device may request a sensing service from the ASP via a UP tunnel or another data path and data protocol.

When the ASP decides to trigger cellular network sensing, the ASP may invoke a related API set provided by the AF 232 to specify a list of sensors to participate in the sensing or a list of sensing targets (objects) to be monitored. The list of sensors or the list of sensing targets may be indicated by one of the following.
External identifier such as the GPSI of the first UE
GPSI of the first UE and indication(s) for sensing device(s) under the first UE
Specific area
Object type identifier (e.g. person, car, unmanned aircraft system, industrial machine, robot)
Subscription correlation ID and an object ID
User identity profile
Application ID

The GPSI may not only identify a specific UE that the ASP intends to trigger for sensing, but also may indicate a sensing trigger for all devices of a UE set according to a service level agreement (SLA). The ASP may request the use of a sensing capability for all devices or specific devices of the UE set by attaching a first sensing device identifier to the GPSI of the first UE.

When the ASP has insufficient information on devices capable of generating sensing data, the ASP may first request sensing based on a specific area. Once information on devices or objects within the specific area is obtained, the ASP may specify device(s) or object(s) for additional sensing. Since an object to be sensed cannot be identified only by area information, the ASP may include an object type along with the area information. If the object type is specified, the cellular network may selectively monitor only the indicated object.

When the object is sensed or when the object is configured in the cellular network according to an SLA between the MNO and the ASP, both the cellular network system and the ASP may assign an ID to the object. The IDs, represented as an external object ID in the ASP and as an internal object ID in the cellular network system, may differ between the two systems.

An object may be indicated in three manners: (i) assigning a globally unique ID if the object has a global unique ID such as a permanent equipment identifier (PEI), (ii) combining a service subscription correlation ID with a unique object ID, or (iii) assigning a unique object ID in the cellular network, such as a network access identifier (NAI) (e.g. object1@SUPI of the first user).

When the cellular network assigns an object identifier, the cellular network may manage an object identity profile that describes various attributes such as type, shape, communication capability, mobility pattern, location, and a set associated with the UE.

Since each attribute is identified through the object identifier, the object may have multiple identifiers. The cellular network may expose related object attributes to the ASP upon request, and the NEF 230 may map the identifiers to external identifiers.

When the ASP requests activation of sensing related to the object via the NEF 230, the NEF 230 may map the external object identifier to the internal object identifier and instruct the SeCF 212 to start sensing by indicating the internal object identifier.

The SeCF 212 may retrieve information on all connected UEs from the storage functions such as the UDM 220 and the UDR 222 by using the object identifier as a data key, and may determine a UE to trigger sensing for the object. The SeCF 212 may be collocated with the PCF as a logical function, and perform some operations in cooperation with the SeMF 214, etc.

When the cellular network does not have the object identifier representing the object requested by the ASP, an error message may be transmitted to the ASP via the AF 232. The error message may include a description of a cause of the error (e.g. the object has not been sensed in the cellular network).

Upon receiving the error message, the ASP may additionally request sensing, and the additional request may be indicated by a likely area where the object may be located or by using the first UE and/or a first user device accessible via the first UE for sensing the object.

For secure management of sensing results, the cellular network may assign application identifiers to objects, UEs, and devices stored in cellular NFs such as the UDM 220 and the UDR 222, and may separately manage participants of sensing for each application.

Through the application identifiers, the cellular network may determine the UEs and devices participating in sensing requests of a specific application from the ASP as UEs and devices capable of using the application. The cellular network may consider authority to access objects and devices based on the provided information.

In exemplary embodiments of FIG. 3 to FIG. 8 to be described later, operations described as operations of a specific NF may be performed in a similar NF in alternative exemplary embodiments.

For example, operations described as operations of the AF may be performed by the first NF including AF, NEF, SCEF, and SePF.

Operations described as operations of the SeCF may be performed by the second NF including SeCF, SeMF, PCF, AMF, SePF, and SeRF in alternative exemplary embodiments.

In alternative exemplary embodiments, the UDM and/or the UDR may also be included in the second NF.

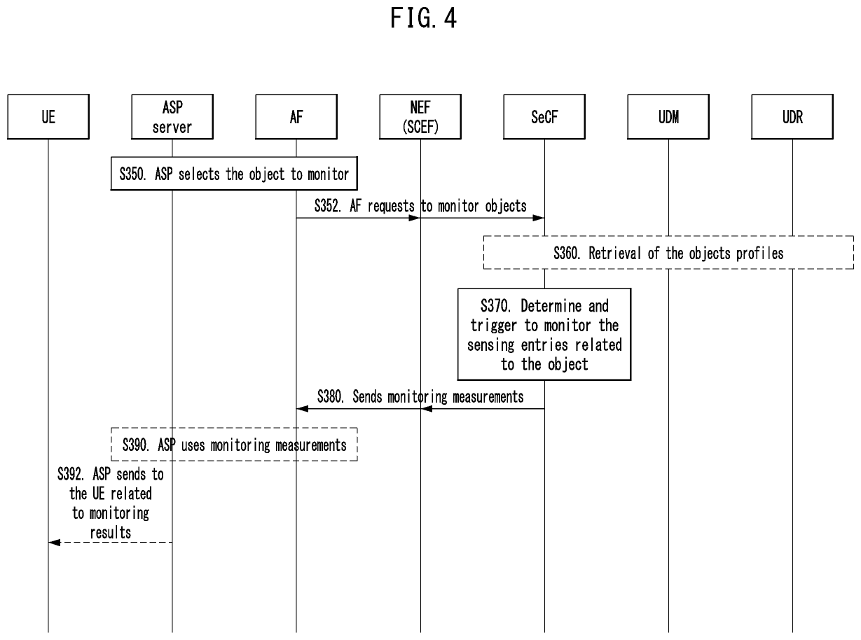

FIG. 3 and FIG. 4 are operation flowcharts illustrating exemplary embodiments of a process for detecting and monitoring objects for an object sensing method according to an exemplary embodiment of the present disclosure.

The present disclosure describes a role of the ASP in triggering object monitoring. However, other network entities such as PCF and/or OAM may also initiate object monitoring and discovery for various reasons such as network optimization or provision of object-related services.

Referring to FIG. 3, a UE or a device associated with the UE may determine whether to discover or monitor an object based on a configuration of an app or firmware (S301). When the UE requests cellular network sensing, the UE may transmit a sensing request to the ASP using an API provided by an application (S302).

The ASP may decide whether to use sensing capabilities of the cellular network system based on internal logics and the request of the UE. When it is decided to use the sensing capabilities, the ASP may request object monitoring from the AF (S303). The ASP may check available information on the object in the cellular network system.

When object identification information between the ASP and the cellular network is not synchronized in step S303, the ASP may provide sub-information such as area information or an external identifier (e.g. GPSI of a nearby UE, an application ID, or an object type indicator (e.g. UAS, person, or Bluetooth device) to assist discovery of the object and may transmit discovery information of the object to the AF. Conversely, when the ASP has previously triggered sensing for the same object, steps S310, S320, S330, and S340 to be described later may be omitted.

The AF may request confirmation of the availability of the sensing data of the object. When the sub-information has been provided in steps S301 to S303, the sub-information may be included in discovery requests (S310).

When the cellular network system does not expose internal identifiers and internal information to the ASP, the ASP may request the service from the AF using an exposed external identifier, and the NEF may convert the external identifier information into internal identifier information. For example, the NEF may convert the GPSI, which is an external identifier of the UE, into an internal identifier such as the SUPI, convert external area information into an internal identifier such as a cell ID or a TAI, convert an external application ID into an internal application ID, and convert an object type indicator into an object type identifier. When the request is properly approved by the cellular network system, the AF and the NEF may manage the sensing service using a service subscription identifier.

When the SeCF receives the sensing request, the SeCF may discover the requested object using the provided sub-information (S320). Through a result of the discovery process, an object profile may be generated or updated, and an associated UE set for each UE subscription data in network storage functions such as the UDM and the UDR may be updated (S320).

The NEF or the SeCF may retrieve a list of all objects satisfying service request conditions based on the information provided from the UDM and the UDR in step S310 (S330). This list may include identifiers of all objects satisfying the conditions.

The NEF may convert all internal identifiers into external identifiers and may transmit information of the converted external identifiers to the ASP via the AF (S340).

Referring to FIG. 4, when receiving an information set including identifiers, the ASP may analyze the data. The ASP may first classify the information set (object type, location, accessible UE environment, and the like), and may pair objects having similar information between the ASP's own data and the data retrieved from the NEF.

When a pair is established between an object in the ASP data and an object retrieved from the NEF, the ASP may recognize the paired information as belonging to the same object, and otherwise may regard the object as newly added. To improve the accuracy of object classification, the ASP may infer relationships between the information using an AI/ML model. The ASP may repeatedly trigger steps S350 to S390 based on a request or a purpose on an application to synchronize and utilize the information.

Based on the classified information, the ASP may select target objects to be monitored (S350).

The AF may transmit an object monitoring request to the SeCF by indicating object identifiers (S352). When the AF is not trusted, the request may be delivered via the NEF.

When the request is received, the SeCF may retrieve associated UE set information from network storage functions such as the UDR via the UDM (S360). In this case, the object identifier may be used as a data key. The SeCF may also retrieve additional information on the object to identify the monitoring method and participants.

Based on the retrieved information, the SeCF may determine participants (e.g. UE, RAN, devices) to monitor the object and may instruct the participants to activate monitoring (S370).

When the SeCF receives measurement results from the participants, the SeCF may analyze the data and may report results to the AF via the NEF (S380). Step S380 may be iterated as many times as necessary according to the request of step S352.

The ASP may analyze the monitoring results and may utilize the results for its own purpose (S390).

When steps S301 and S302 are triggered as described above, the ASP may transmit the monitoring results to the UE (S392).

This structured approach may provide a systematic and efficient method for discovering and monitoring objects in the cellular network by leveraging both external and internal data sources and processing mechanisms.

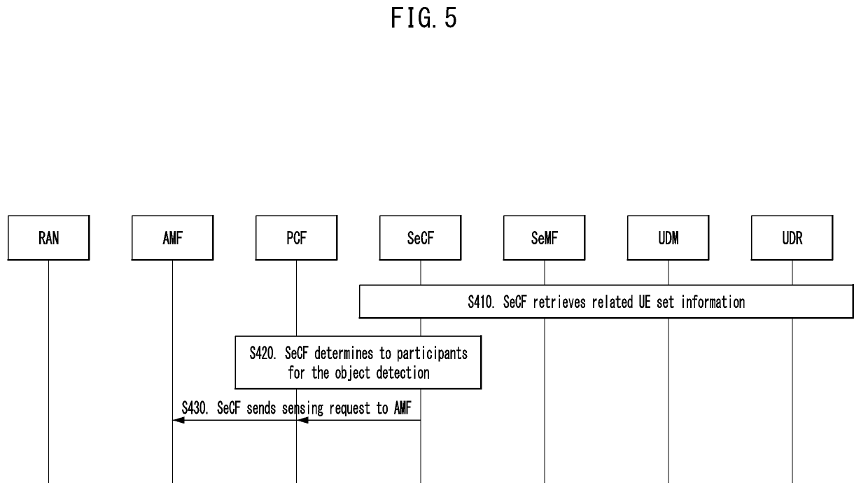

FIG. 5 to FIG. 8 are operation flowcharts illustrating exemplary embodiments of processes of updating information of target objects, sensing devices, and/or associated UEs and performing actual sensing for an object sensing method according to an exemplary embodiment of the present disclosure.

The processes illustrated in FIG. 5 to FIG. 8 may be applied as an exemplary embodiment of step S320 of FIG. 3, for example, but the spirit of the present disclosure is not limited to such specific exemplary embodiments.

Referring to FIG. 5, the SeCF may retrieve all UE set information within a target area (S410).

Based on the object discovery request described in step S310, the SeCF may select participants for object/device sensing (S420). For example, when area information is provided, the SeCF may select UEs and RANs in the corresponding area. When the ASP transmits UE-related information via the AF, the SeCF may select UEs and RANs serving the corresponding UE. The SeCF may instruct the SeMF to collect sensing measurement data using a specified reporting scheme (e.g. via NAS or UP).

The SeCF may transmit a request to activate a sensing capability to UEs associated with selected devices and to RANs selected in step S420 via serving AMFs of the selected UEs (S430). The request may specify device identifiers and UE identifiers, and sensing capabilities (e.g. GPS, camera, NR sensing, frequency) required for both the devices and the UEs.

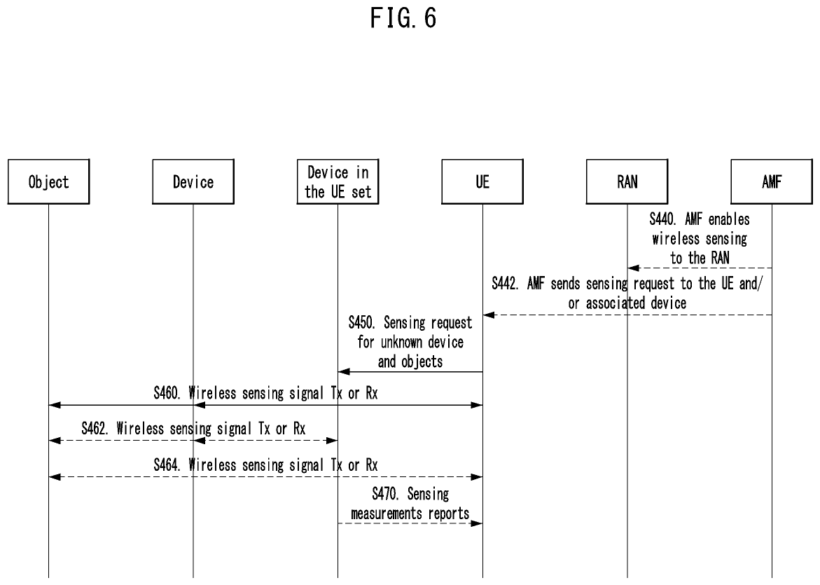

Referring to FIG. 6, the AMF may activate sensing capabilities in the selected RANs and may transmit a sensing request to UEs associated with the selected devices (S440, S442). The sensing requests of steps S440 and $442 may typically be transmitted through NAS messages.

When identifiers of devices within a UE set are included in the sensing request message, the UE may issue a request to the selected devices within the UE set based on both the UE configuration and the device application configuration (S450). In this case, the specified device may be a device that is not directly known to the cellular network side.

Depending on a required sensing mode (e.g. monostatic or bistatic), sensing participants (e.g. devices, UEs, RANs) may perform operations for wireless sensing (S460, S462, S464).

The UE may collect sensing measurement values of the devices through a UE app (S470).

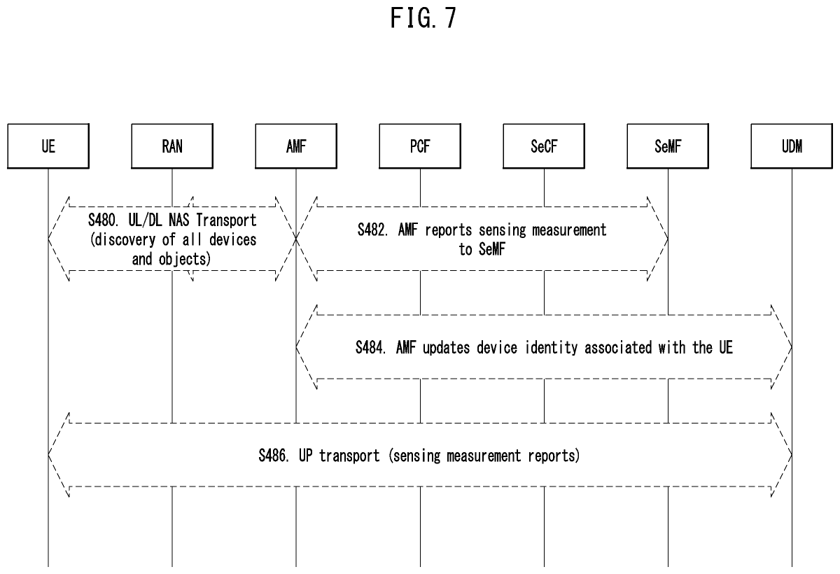

Referring to FIG. 7, after receiving sensing measurement values from the devices or after measuring wireless sensing signals by the UE itself, the UE may transmit sensing measurement data to the AMF through NAS transport (S480). At the same time, the RAN may report wireless sensing signal measurement values to the AMF (S480), and the AMF may deliver sensing measurement values to the SeMF (S482). In this case, step S482 may be performed based on the reporting method specified in step S420.

When the UE reports discovery or detection of new devices or objects, the AMF may update device identities associated with the UE in the UDM (S484).

The UE may also report its own sensing measurement values and sensing measurement values of related devices through UP transport by specifying the IP address of the SeMF (S486). In an exemplary embodiment, steps S480, S482, and S484 may be performed, and in another exemplary embodiment, step S486 may be performed. Which exemplary embodiment is selected to be performed may depend on conditions specified in step S420 (e.g. presence of the IP address of the SeMF and indicated reporting method).

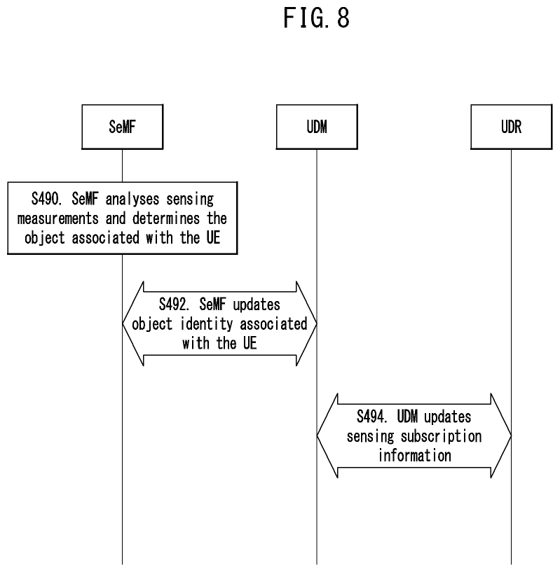

Referring to FIG. 8, when the SeMF receives sensing measurement information, the SeMF may analyze all data to detect objects sensed by the UEs (S492). When newly sensed objects or devices are identified, the SeMF may assign identifiers (e.g. locations, associated UEs, object types) to the entities (objects or devices).

Based on the result of step S490, the SeMF may request the UDM to register and/or update object identities including sensing device sets for the UE set (S492).

The UDM may register and/or update object identities of the UEs and sensing device sets as sensing subscription information.

This process may ensure systematic object and device sensing and monitoring through integrated cellular network operations and may improve efficiency and effectiveness of real-time data collection and analysis.

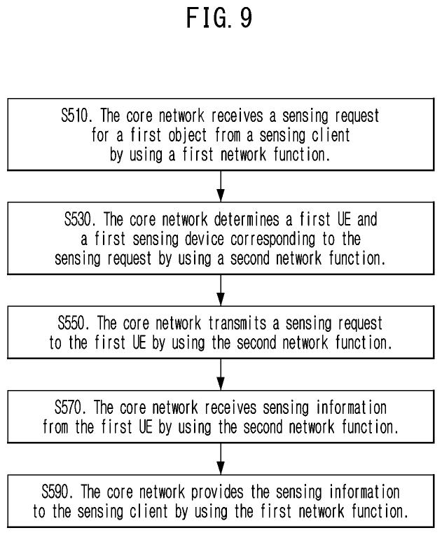

FIG. 9 is an operation flowchart illustrating exemplary embodiments of processes of handling sensing requests and determining sensing devices and/or associated UEs responding to sensing requests for an object sensing method according to an exemplary embodiment of the present disclosure.

Referring to FIG. 9, an object sensing method using a mobile communication network according to an exemplary embodiment of the present disclosure may include a step S510 in which a core network receives a sensing request for a first object from a sensing client using at least one first NF, a step S530 in which the core network determines a first sensing device and a first UE capable of communicating with the first sensing device corresponding to the sensing request using at least one second NF, and a step S550 in which the core network transmits the sensing request to the first UE using the at least one second NF.

In the step S530 of determining the first sensing device and the first UE, the first sensing device and the first UE may be determined based on an information set for the first UE that includes information on the first sensing device to participate in sensing for the first object and information on the associated first UE capable of communicating with the first sensing device through a communication technology different from a mobile communication technology corresponding to the core network.

In the step S530 of determining the first sensing device and the first UE, the first sensing device and the first UE may be determined based on an information set for the first object that includes information on the first sensing device to participate in sensing for the first object and information on the associated first UE capable of communicating with the first sensing device through a communication technology different from a mobile communication technology corresponding to the core network.

An object sensing method using a mobile communication network, according to an exemplary embodiment of the present disclosure, may further comprise: a step S570 in which the core network receives, using the at least one second network function, sensing information of the first object corresponding to the sensing request; and a step (not shown) in which the core network updates, using the at least one second network function, information on the first object, the first sensing device, or the first UE associated with the first sensing device based on the sensing information.

An object sensing method using a mobile communication network, according to an exemplary embodiment of the present disclosure, may further comprise: a step (not shown) in which the core network updates, using the at least one second network function, information on the first object, the first sensing device, or the first UE associated with the first sensing device based on updated mobility information of the first object, the first sensing device, or the first UE associated with the first sensing device.

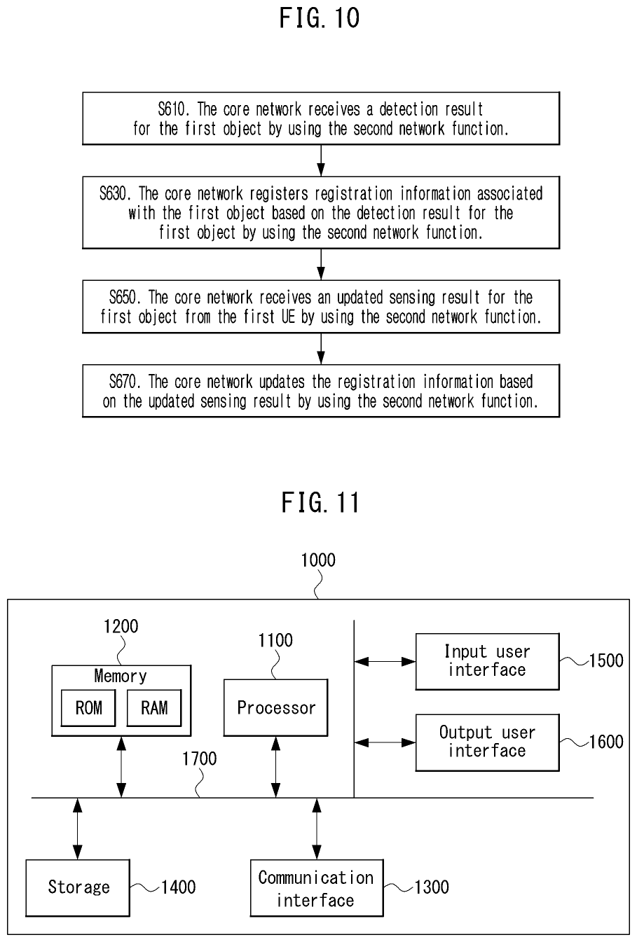

The step (not shown) of updating information on the first object, the first sensing device, or the first UE associated with the first sensing device is described with reference to FIG. 7 above and/or FIG. 10 below.

Meanwhile, in an exemplary embodiment of the present disclosure, an object sensing method using a mobile communication network may further comprise a step S590 in which the core network provides sensing information to a sensing client using at least one first network function.

A part or all of step S510 may be performed through steps S303 and S310 of FIG. 3, steps S350 and S352 of FIG. 4, and the like. In this case, the sensing request may include a discovery request of the object, a detection request of the object, or a monitoring request of an already detected object.

A part or all of step S530 may be performed through steps S360, S370, and S380 of FIG. 4 and steps S410, S420, and S430 of FIG. 5.

A part or all of step S550 may be performed through step S340 of FIG. 3, step S380 of FIG. 4, step S430 of FIG. 5, and steps S440 and S442 of FIG. 6.

A part or all of step S570 may be performed through step S470 of FIG. 6 and step S480, S482, S484, and S486 of FIG. 7.

A part or all of step S590 may be performed through step S390 of FIG. 4.

FIG. 10 is an operation flowchart illustrating exemplary embodiments of a process for registering and/or updating sensing registration information for an object sensing method according to an exemplary embodiment of the present disclosure.

Referring to FIG. 10, in another exemplary embodiment of the present disclosure, an object sensing method using a mobile communication network may comprise: step S610 in which a core network receives, using at least one second network function, a detection result for a first object corresponding to a sensing request received from a sensing client using at least one first network function; and a step S630 in which the core network registers, as registration information corresponding to the first object, a first UE, or the sensing request, information on the first object, a first sensing device capable of sensing the first object, and the associated first UE capable of communicating with the first sensing device, based on the detection result for the first object using the at least one second network function.

In an object sensing method using a mobile communication network according to another exemplary embodiment of the present disclosure, the registration information may include information on the associated first UE that is capable of communicating with the first sensing device through a communication technology different from a mobile communication technology corresponding to the core network.

In an object sensing method using a mobile communication network according to another exemplary embodiment of the present disclosure, the method may further comprise: a step S650 in which the core network receives, using the at least one second network function, sensing information (sensing result) of the first object corresponding to the sensing request; and a step S670 in which the core network updates the registration information based on the sensing information using the at least one second network function.

In an object sensing method using a mobile communication network according to another exemplary embodiment of the present disclosure, the method may further comprise a step in which the core network updates the registration information based on updated mobility information of the first object, the first sensing device, or the first UE associated with the first sensing device using the at least one second network function.

In an object sensing method using a mobile communication network according to another exemplary embodiment of the present disclosure, the method may further comprise: a step in which the core network receives a monitoring request for the first object using the at least one first network function; a step in which the core network determines, using the at least one second network function and based on the registration information, the first sensing device and the first UE to respond to the monitoring request; and a step in which the core network transmits the sensing request to the first UE using the at least one second network function.

A part or all of steps S610 and S650 may be performed through steps S480, S482, S484, and S486 of FIG. 7 and step S490 of FIG. 8.

A part or all of steps S630 and S670 may be performed through step S320 of FIG. 3, step S484 of FIG. 7, and steps S490, S492, and S494 of FIG. 8.

FIG. 11 is a conceptual diagram illustrating an example of a generalized computing system in which an entity within the core network 200 capable of performing at least a portion of the processes of FIGS. 1 to 10, a sensing entity participating in the sensing process in interaction with the core network 200, or a part thereof may be implemented.

At least some of the processes, such as sensing, control, computation, data processing, data transmission, and reception, which are performed by an entity performing at least a part of NFs in the core network 200 and the sensing entity involved in the sensing process for the target according to exemplary embodiments of the present disclosure, may be executed by the computing system 1000 of FIG. 11.

Referring to FIG. 11, the computing system 1000 according to an exemplary embodiment of the present disclosure may include a processor 1100, a memory 1200, a communication interface 1300, a storage device 1400, an input interface 1500, an output interface 1600, and a bus 1700.

The computing system 1000 according to an exemplary embodiment of the present disclosure may include the at least one processor 1100 and the memory 1200 that stores instructions causing the at least one processor 1100 to perform at least one step. At least a portion of the steps of the method according to an exemplary embodiment of the present disclosure may be performed by the at least one processor 1100 that loads the instructions from the memory 1200 and executes the instructions.

The processor 1100 may refer to a central processing unit (CPU), a graphics processing unit (GPU), or a dedicated processor on which the methods according to the exemplary embodiments of the present disclosure are performed.

Each of the memory 1200 and the storage device 1400 may include at least one of a volatile storage medium and a non-volatile storage medium. For example, the memory 1200 may include at least one of a read-only memory (ROM) and a random access memory (RAM).

The computing system 1000 may further include the communication interface 1300 for performing communication through a wireless network.

The computing system 1000 may further include the storage device 1400, the input interface 1500, and the output interface 1600.

The respective components included in the computing system 1000 may communicate with one another by being connected via the bus 1700.

A communication network system controlling sensing according to an exemplary embodiment of the present disclosure may include at least one entity, and the at least one entity may include the computer-readable memory 1200 storing at least one instruction, and the processor 1100 executing the at least one instruction.

As described above, the at least one entity in the communication network system controlling sensing according to an exemplary embodiment of the present disclosure may implement at least one NF illustrated in the exemplary embodiments of FIGS. 1 to 10.

The at least one entity in the communication network system controlling sensing according to an exemplary embodiment of the present disclosure may perform procedures and operations illustrated in the exemplary embodiments of FIGS. 1 to 10.

An example of the computing system 1000 of the present disclosure may include a communicable desktop computer, laptop computer, notebook, smartphone, tablet PC, mobile phone, smart watch, smart glasses, e-book reader, portable multimedia player (PMP), portable gaming device, navigation device, digital camera, digital multimedia broadcasting (DMB) player, digital audio recorder, digital audio player, digital video recorder, digital video player, or personal digital assistant (PDA), and/or the like.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A communication system providing object sensing, comprising at least one entity, wherein the at least one entity comprises:
a memory storing at least one computer-readable instruction; and
a processor executing the at least one instruction;
wherein the at least one entity is configured to:
receive, using at least one first network function within a core network, a sensing request for a first object from a sensing client;
determine, using at least one second network function within the core network, a first sensing device responding to the sensing request and a first user equipment (UE) capable of communicating with the first sensing device; and
transmit, using the at least one second network function, the sensing request to the first UE.

2. The communication system of claim 1, wherein in the determining of the first sensing device and the first UE, the at least one entity is configured to: determine the first sensing device and the first UE based on an information set for the first UE, the information set including information on the first sensing device participating in sensing for the first object and information on the associated first UE capable of communicating with the first sensing device through a communication technology different from a mobile communication technology corresponding to the core network.

3. The communication system of claim 1, wherein in the determining of the first sensing device and the first UE, the at least one entity is configured to: determine the first sensing device and the first UE based on an information set for the first object, the information set including information on the first sensing device participating in sensing for the first object and information on the associated first UE capable of communicating with the first sensing device through a communication technology different from a mobile communication technology corresponding to the core network.

4. The communication system of claim 1, wherein the at least one entity is configured to:
receive, using the at least one second network function, sensing information of the first object corresponding to the sensing request; and
update, using the at least one second network function, information on the first object, the first sensing device, or the first UE associated with the first sensing device based on the sensing information.

5. The communication system of claim 1, wherein the at least one entity is configured to: update, using the at least one second network function, information on the first object, the first sensing device, or the first UE associated with the first sensing device based on updated mobility information of the first object, the first sensing device, or the first UE associated with the first sensing device.

6. The communication system of claim 1, wherein the at least one entity is configured to:
receive, using the at least one second network function, a detection result for the first object; and
register, using the at least one second network function, information on the first object, the first sensing device capable of sensing the first object, and the associated first UE capable of communicating with the first sensing device as registration information corresponding to the first object, the first UE, or the sensing request, based on the detection result for the first object.

7. The communication system of claim 6, wherein the registration information includes information on the associated first UE capable of communicating with the first sensing device through a communication technology different from a mobile communication technology corresponding to the core network.

8. The communication system of claim 6, wherein the at least one entity is configured to:
receive, using the at least one second network function, sensing information of the first object corresponding to the sensing request; and
update, using the at least one second network function, the registration information based on the sensing information.

9. The communication system of claim 6, wherein the at least one entity is configured to: update, using the at least one second network function, the registration information based on updated mobility information of the first object, the first sensing device, or the first UE associated with the first sensing device.

10. The communication system of claim 6, wherein the at least one entity is configured to: retrieve, using the at least one second network function, information of the first sensing device and the first UE responding to the sensing request from a unified data management (UDM) or a unified data repository (UDR).

11. A method of object sensing using a mobile communication network, the method comprising:
receiving, by a core network using at least one first network function, a sensing request for a first object from a sensing client;
determining, by the core network using at least one second network function, a first sensing device responding to the sensing request and a first user equipment (UE) capable of communicating with the first sensing device; and
transmitting, by the core network using the at least one second network function, the sensing request to the first UE.

12. The method of claim 11, wherein in the determining of the first sensing device and the first UE, the first sensing device and the first UE are determined based on an information set for the first UE, the information set including information on the first sensing device participating in sensing for the first object and information on the associated first UE capable of communicating with the first sensing device through a communication technology different from a mobile communication technology corresponding to the core network.

13. The method of claim 11, wherein in the determining of the first sensing device and the first UE, the first sensing device and the first UE are determined based on an information set for the first object, the information set including information on the first sensing device participating in sensing for the first object and information on the associated first UE capable of communicating with the first sensing device through a communication technology different from a mobile communication technology corresponding to the core network.

14. The method of claim 11, wherein further comprising:
receiving, by the core network using the at least one second network function, sensing information of the first object corresponding to the sensing request; and
updating, by the core network using the at least one second network function, information on the first object, the first sensing device, or the first UE associated with the first sensing device based on the sensing information.

15. The method of claim 11, further comprising: updating, by the core network using the at least one second network function, information on the first object, the first sensing device, or the first UE associated with the first sensing device based on updated mobility information of the first object, the first sensing device, or the first UE associated with the first sensing device.

16. A method of object sensing using a mobile communication network, the method comprising:
receiving, by a core network using at least one second network function, a detection result for a first object corresponding to a sensing request received from a sensing client via at least one first network function; and
registering, by the core network using the at least one second network function, information on the first object, a first sensing device capable of sensing the first object, and an associated first user equipment (UE) capable of communicating with the first sensing device as registration information corresponding to the first object, the first UE, or the sensing request, based on the detection result for the first object.

17. The method of claim 16, wherein the registration information includes information on the associated first UE capable of communicating with the first sensing device through a communication technology different from a mobile communication technology corresponding to the core network.

18. The method of claim 16, further comprising:
receiving, by the core network using the at least one second network function, sensing information of the first object corresponding to the sensing request; and
updating, by the core network using the at least one second network function, the registration information based on the sensing information.

19. The method of claim 16, further comprising: updating, by the core network using the at least one second network function, the registration information based on updated mobility information of the first object, the first sensing device, or the first UE associated with the first sensing device.

20. The method of claim 16, further comprising:
receiving, by the core network using the at least one first network function, a monitoring request for the first object;
determining, by the core network using the at least one second network function, the first sensing device and the first UE responding to the monitoring request based on the registration information; and
transmitting, by the core network using the at least one second network function, the sensing request to the first UE.
